(19) United States
(12) Patent Application Publication
(10) Pub. No.: US 2013/0195301 A1
(43) Pub. Date: Aug. 1, 2013

(54) Nerve-Skin Contact Hearing Aid NERSCHA

(71) Applicant: Robert L. Boucher, Overland Park, KS (US)

(72) Inventor: Robert L. Boucher, Overland Park, KS (US)

(21) Appl. No.: 13/323,838

(22) Filed: Feb. 1, 2012

(51) Int. Cl. H04R 25/00

(52) U.S. Cl. 381/320

(57) ABSTRACT

A device to be used as both a hearing aid. The device consists of a microphone (FIG. 1) wired to an amplifier (FIG. 2) wired to a speaker (FIG. 3). Sound from the speaker (FIG. 3) is aimed at and pressed against a person's skin (FIG. 3). A deaf person will wear this device while continuing the use of sign language and lip reading. With use and over a period of time the vibrations felt will come to be recognized as words.

### BACKGROUND

1. Field of Invention

This invention relates to hearing aids, specifically to a dramatically improved hearing aid which doesn't depend on a functional ear drum and it operates off of the sense of touch.

2. Description of Prior Art

The medical industry generally has available hearing aids for people who have a partial hearing loss. This type of hearing aid receives the sound, amplifies it and delivers it to the ear drum. So with this type of hearing aid the ear drum remains crucial to hearing. U.S. Pat. No. 4,400,590 to Robin P. Michelson for the cochlear implant calls for an operation to repair a portion of the body's system which works with the ear drum to hear. Once again this hearing aid relies on the ear drum to hear. The Nerve Skin Contact Hearing Aid (NERSCHA) does not rely on the ear drum at all. It relies on the sense of touch. When a person is totally deaf this invention is the only hearing aid that will help them to hear.

### Objects and Advantages

Accordingly there are objects and advantages of the present art:
(a) To provide the ability to hear to those who do not have a functional ear drum and are totally deaf.
(b) To provide hearing at a very low cost.

### DRAWING FIGURES

FIG. 1 shows a parallelogram which represents a microphone. A wire represented by a line FIG. 1 is attached to the right side of said microphone and is strung to the right in the direction of FIG. 2. Said wire is attached electrically to said microphone.

FIG. 2 shows said wire from said microphone leading into the left side of a rectangle. The rectangle represents an amplifier. Another wire connected to the right side of said amplifier is strung off to the right in the direction of FIG. 3.

FIG. 3 shows said wire coming in from said amplifier in FIG. 2. Said wire electrically connects to a circle which represents a speaker. The said speaker shall be oriented such that its sound will be directed into the human body. Said speaker will also be set up to press against the human body. Said speaker is shown pressing into the stomach.

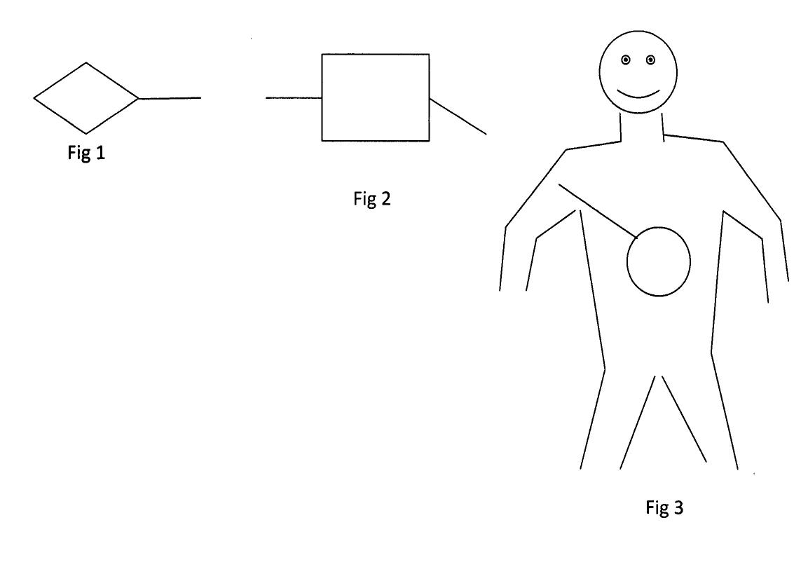

### DESCRIPTION OF INVENTION

In FIG. 3 said speaker is pressed against the stomach such that said speaker's moving parts that create the sound waves makes intimate contact with skin. Instead of the stomach as the point of contact the user could press his finger tips against the speaker material. Therefore the movement of said speaker material can be felt by nerve endings in the skin. A speaker selected for this use should allow for intimate contact with the skin. A speaker material should be capable of transmitting its sound vibrations while in contact with the human body without significant loss of vibrations. Finger tips may provide the most sensitivity and minimally diminish the movement of the speaker material and therefore be the most effective.

The users brain will need time to develop the ability to interpret the said vibrations. Each human sense (i.e. hearing, sight, touch, smell) is interpreted by its own unique and exclusive part of the brain. A part of the brain used to manage sense of touch information normally has experienced interpreting minimally challenging things such as how fabric feels, how skin feels and hair feels etc. Upon first use of this invention the touch sensory part of one's brain may not have the capacity to interpret the said vibrations representing 450,000 English words. They may feel meaningless. A deaf person using this invention while reading lips or sign language may begin to make a connection between said vibrations and their corresponding words after wearing said hearing aid for a couple of months.

### SUMMARY

In essence this device is a hearing aid to be used by the totally deaf and does not require a user to have a functional ear drum. It will work with the human sense of touch to deliver information to the users brain for evaluation and interpretation. Sound travels through the air, then through a microphone, then through an amplifier, then through a speaker, then to nerve endings in the skin. The skin is in full contact with the moving part of the speaker so that sound creating vibrations from the speaker are felt by the nerve endings in the skin. These nerve endings transmit this information to the user's brain for review and interpretation. The vibration sensations created by the speaker representing each word is unique enough for the brain to learn to distinguish one word from another. A period of learning and adjustment may be needed to develop the ability to interpret these vibrations and make distinctions between all words. The best learning process may be to continue to rely on lip reading and sign language while the system is in contact with one's nerve endings. Over time the user will learn and adapt.

The design and construction of this invention isn't critical. A microphone electrically connected to an amplifier which is in turn electrically connected to a standard speaker. A person puts their fingers on the speaker and feels the vibrations. What is critical is the patience and perseverance the user needs to have to give his brain time to enhance itself so he can begin to understand the vibrations. The user will need to learn one little piece at a time. Learn the difference between a two syllable word and a three syllable word. Learn the difference between how the sound “A” feels and how “E” feels. It's not just a matter of learning how all the sounds feel. It is also a matter of giving the brain time to grow and strengthen itself as physical changes will occur with constant trying. Just as a blind persons hearing is significantly more powerful than the hearing of people with sight a deaf persons sense of touch will become capable of interpreting how words feel using this invention. Their own pronunciations will also improve as feedback from this invention shows the users what adjustments to make.

### CONCLUSIONS, RAMIFICATIONS, AND SCOPE OF INVENTION

Although the description contains many specificities, these should not be construed as limiting the scope of the invention but as merely providing illustrations of some of the presently observed embodiments of this invention. For example the system's microphone and amplifier could be replaced by a stereo, iPod, tape or CD player.

Thus the scope of this invention should be determined by the appended claims and their legal equivalents, rather than by the examples given.

I claim:

1. A hearing aid for the totally and partially deaf comprising:
a. A sound receiving device or microphone to receive sounds, convert them to an electrical signal and transmit the said signal.
b. A signal amplifying device or amplifier to ensure adequate volume is attained.
c. A signal interpretation device or speaker to recreate the said sound.
d. A means of connecting said devices together and connecting said speaker to the skin to cause the nerves in the skin to feel the said sound.
